(19) United States
(12) Patent Application Publication
(10) Pub. No.: US 2013/0008727 A1
(43) Pub. Date: Jan. 10, 2013

(54) WIND SHIELD FOR A TRUCK SCALE

(76) Inventor: DENIS L. NELSON, Council Bluffs, IA (US)

(21) Appl. No.: 13/539,644

(22) Filed: Jul. 2, 2012

Related U.S. Application Data
(63) Continuation-in-part of application No. 13/135,430, filed on Jul. 5, 2011.

(51) Int. Cl. G01G 19/02

(52) U.S. Cl. 177/133

(57) ABSTRACT

A wind shield for shielding the sides of a truck scale so that the accuracy of the truck scale is less affected by wind forces.

A first flexible sheet member has its upper end secured to the outer side of the first frame siderail, at the upper end thereof, of the truck scale for the length thereof and extends downwardly therefrom outwardly of one side of the truck scale. A second flexible sheet member has its upper end secured to the outer side of the second frame siderail, at the upper end thereof, of the truck scale for the length thereof and extends downwardly therefrom outwardly of the other side of the truck scale. The lower ends of the sheet members are secured in place to either the supporting surface or the ground adjacent thereto.

### CROSS REFERENCE TO RELATED APPLICATION

This is a Continuation-In-Part of application Ser. No. 13/135,430, filed Jul. 5, 2011, entitled A SNOW SHIELD FOR A TRUCK SCALE.

### BACKGROUND OF THE INVENTION

1. Field of the Invention

This invention relates to a wind shield for a truck scale and more particularly to a wind shield which is selectively removably secured to each of the sides of a truck scale to prevent wind from impinging onto the sides of the truck scale.

2. Description of the Related Art

Above-ground truck scales are normally comprised of an elongated, generally rectangular scale deck which is positioned above a supporting surface or foundation with a plurality of spaced-apart load cells being positioned between the foundation and the scale deck. In most of such installations, a gap is present at each side of a scale deck between the lower end of the scale deck and the upper end of the foundation.

Applicant's invention described in the co-pending application solved most, if not all, of the problems associated with snow and debris entering the gap between the lower end of the truck scale and the upper end of the foundation.

Applicant has determined that another problem exists in the truck scales of the prior art. Wind blowing against the sides of the truck scale can affect the accuracy of the truck scale since the wind force may cause the truck scale to be deflected laterally thereby affecting the load cells.

This application is specifically directed to the embodiment of FIGS. 8 and 9.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A wind shield is provided for a truck scale with the truck scale including a substantially horizontally disposed scale deck positioned above a supporting surface. The truck scale has an entry end, an exit end, a first side, a second side, an upper end and a lower end. A plurality of spaced-apart load cells are positioned between the scale deck and the supporting surface with the lower end of the scale deck being positioned above the supporting surface to create a gap at each of the first and second sides thereof. The scale deck has first and second longitudinally extending frame siderails at the first and second sides thereof. Each of the first and second frame siderails has a first end, a second end, inner and outer surfaces and upper and lower ends.

A first elongated flexible sheet member is provided having an upper end, a lower end, a first end, a second end, an inner side and an outer side. The upper end of the first sheet member is selectively detachably secured to the first frame siderail, at the upper end thereof, so that the first end thereof is positioned adjacent the first end of the first frame siderail and so that the second end thereof is positioned adjacent the second end of the first frame siderail. The first sheet member extends downwardly from its upper end to the supporting surface or to the ground adjacent thereto to cover the gap and the first side of the scale deck. The lower end of the first sheet member is operatively secured in place.

A second elongated flexible sheet member is also provided having an upper end, a lower end, a first end, a second end, an inner side and an outer side. The upper end of the second sheet member is secured to the second frame siderail, at the upper end thereof, so that the first end thereof is positioned adjacent the first end of the second frame siderail and so that the second end thereof is positioned adjacent the second end of the second frame siderail. The second sheet member extends downwardly from its upper end to the supporting surface or to the ground adjacent thereto to cover the gap and the second side of the scale deck. The lower end of the second sheet member is operatively secured in place.

In the preferred embodiment, a plurality of horizontally spaced-apart and vertically extending supports, having upper and lower ends, are positioned outwardly of the first and second sides of the first and second frame siderails respectively with the first and second sheet members being selectively removably secured to the supports.

In the preferred embodiment, the lower ends of the first and second sheet members are selectively removably secured to the supporting surface or to the ground adjacent thereto.

In the preferred embodiment, the upper ends of the first and second sheet members are selectively removably secured to the upper ends of the first and second frame siderails respectively and the lower ends of the first and second sheet members are selectively removably secured to the supporting surface or the ground adjacent thereto. The first and second sheet members and the support posts to which they are attached, prevent wind from blowing against the sides of the siderails thereby preventing the wind force from affecting the accuracy of the truck scale.

It is therefore a principal object of the invention to provide a wind shield for a truck scale.

A further object of the invention is to provide a wind shield which is positioned at the opposite sides of a truck scale with the shields preventing wind from impinging upon the truck scale.

A further object of the invention is to provide a wind shield of the type described which is selectively removably secured to opposite sides of the truck scale.

Yet another object of the invention is to provide a wind shield for a truck scale of the type described which enables the scale deck to move with respect to the foundation without interference from the wind shields.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a partial perspective view of a truck scale having a portion of the wind shield secured to one side thereof;

FIG. 2 is a perspective view of a truck scale having the wind shield of this invention secured to one side thereof;

FIG. 3 is a partial perspective view illustrating the manner in which VELCRO® strips are secured to either the upper or lower flanges of one of the frame siderails;

FIG. 4 is a perspective view of one of the support posts of this invention;

FIG. 5 is a perspective view of another support post of this invention;

FIG. 6 is a partial perspective view illustrating the manner in which the shield of this invention is secured to one of the support posts;

FIG. 7 is a partial end view illustrating the manner in which one of the shields is secured to one side of the truck scale;

FIG. 8 is a partial end view illustrating the preferred embodiment of this invention; and

FIG. 9 is a partial perspective view of the embodiment of FIG. 8.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

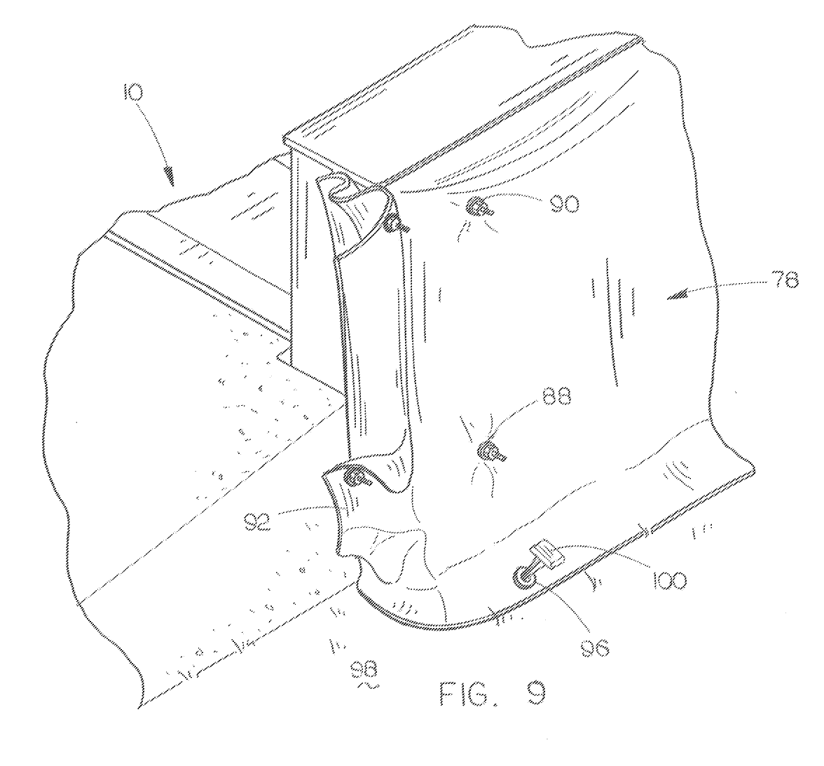

The invention of the co-pending application will be described in detail to assist one to understand the instant invention which is specifically directed to the embodiment of FIGS. 8 and 9. In the co-pending application, the numeral 10 refers to a conventional truck scale which includes a scale deck 12 positioned above a supporting surface or foundation 14 in conventional fashion. A plurality of conventional load cells 16 extend between the foundation 14 and the scale deck 12 in conventional fashion. In many truck scales, a gap 18 is present between the underside of the scale deck 12 and the foundation 14 at each side of the truck scale 10. In blowing wind conditions, wind may blow through the gaps 18 and accumulate between the scale deck and the foundation.

For purposes of description, truck scale 10 will be described as having an entrance end 20, exit end 22, a first side 24, and a second side 26. An entrance ramp 28 is provided at the entrance end 20 of the truck scale 10 and an exit ramp 30 is provided at the exit end 22 of the truck scale.

Truck scale 10 includes a longitudinally extending frame siderail 32 at side 24 thereof and a longitudinally extending frame siderail 34 at side 26 thereof. Inasmuch as frame siderails 32 and 34 are identical, only side frame rail 32 will be described in detail. Siderail 32 includes an upper flange 36, a lower flange 38 and a web 40 extending therebetween. The height or distance between the upper and lower flanges of the siderail 32 will vary considerably from approximately 12 inches to approximately 24 inches. As seen in the drawings, depending upon the particular truck scale, a VELCRO® strip 42 may be secured to the outer end of the lower flange 38 or a VELCRO® strip 44 is secured to the outer end of the upper flange 36. The VELCRO® strips will extend from one end of the frame siderails to the other end thereof. Other similar fastening systems may be employed.

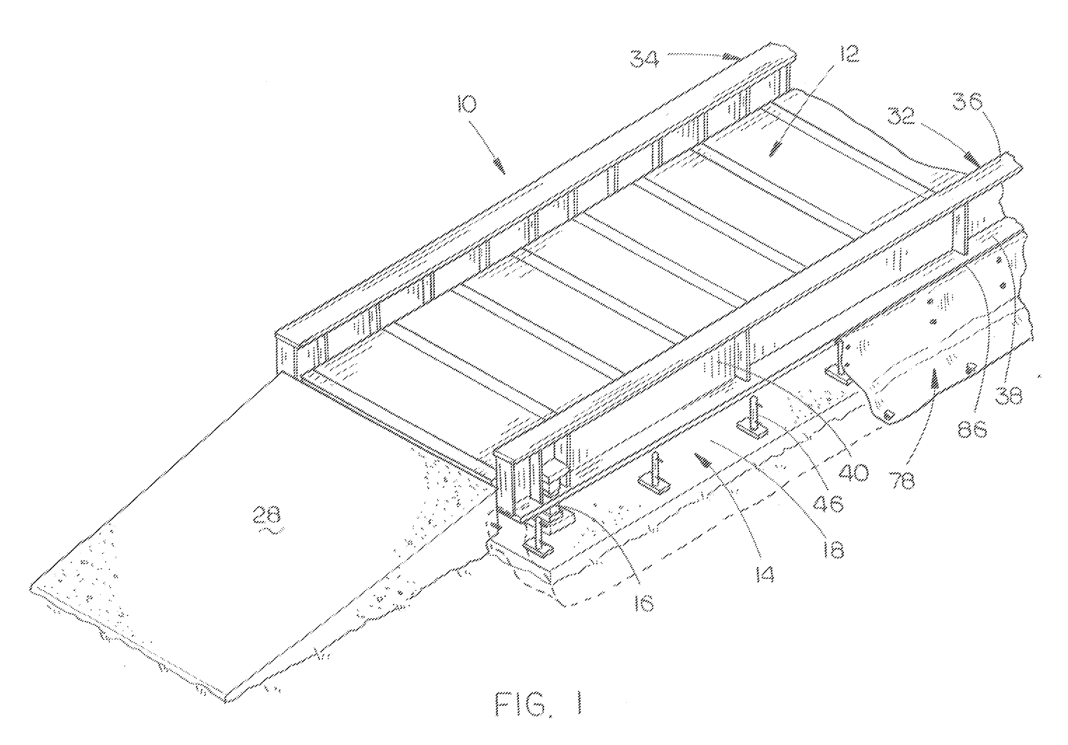

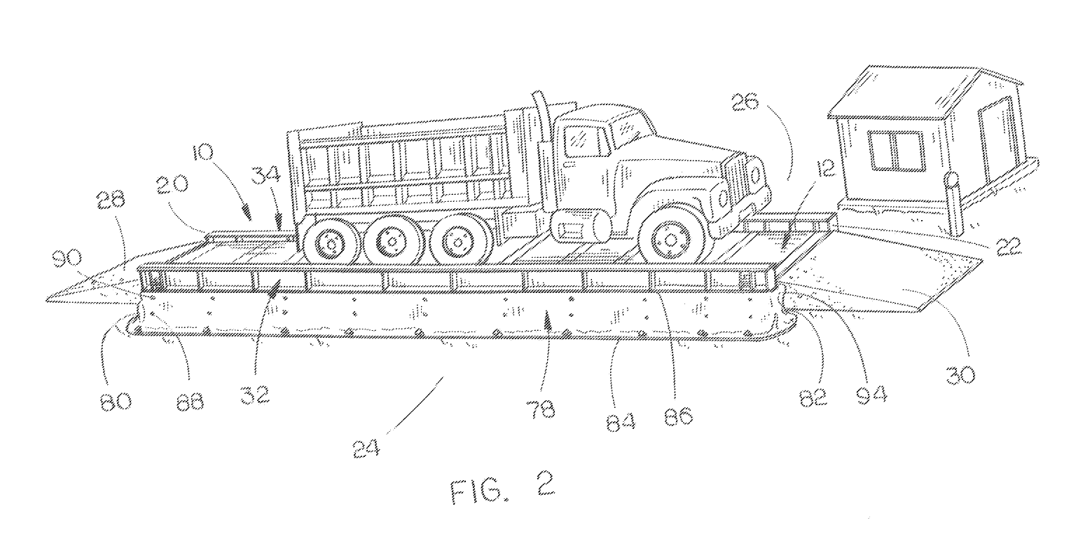

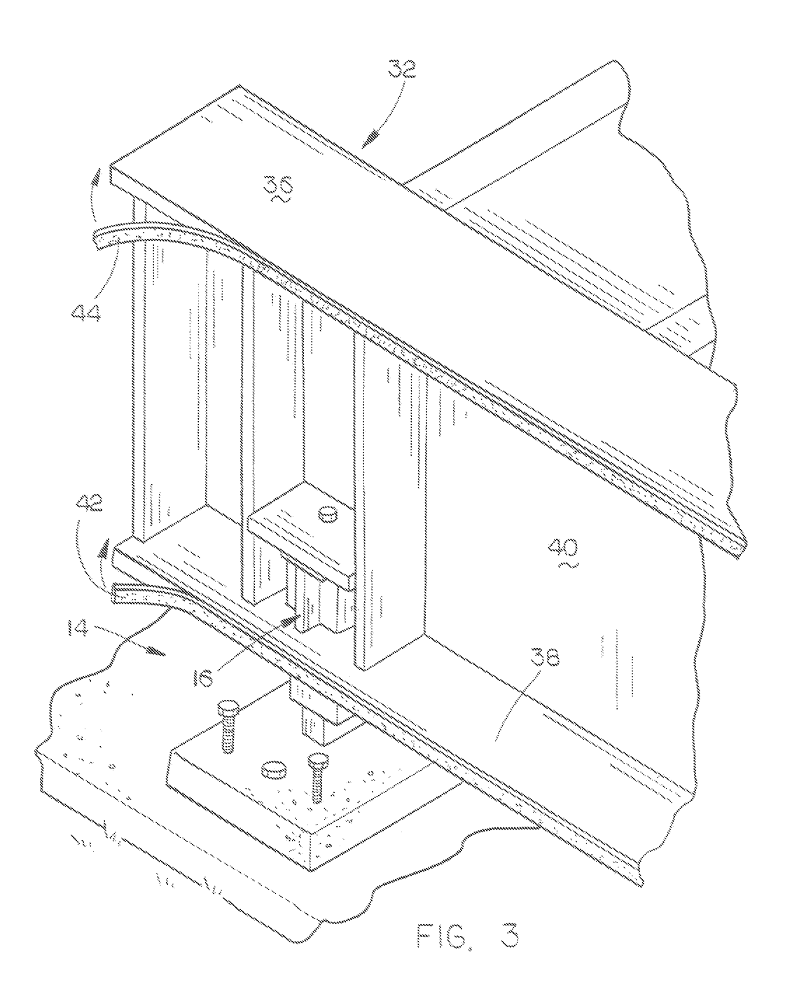

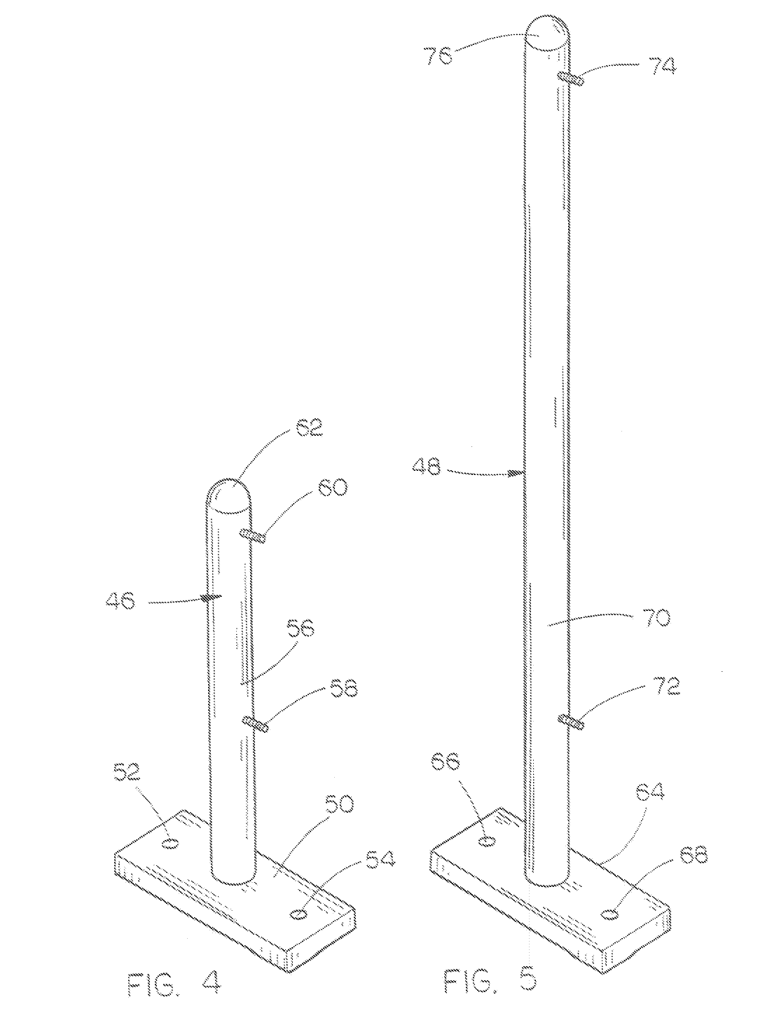

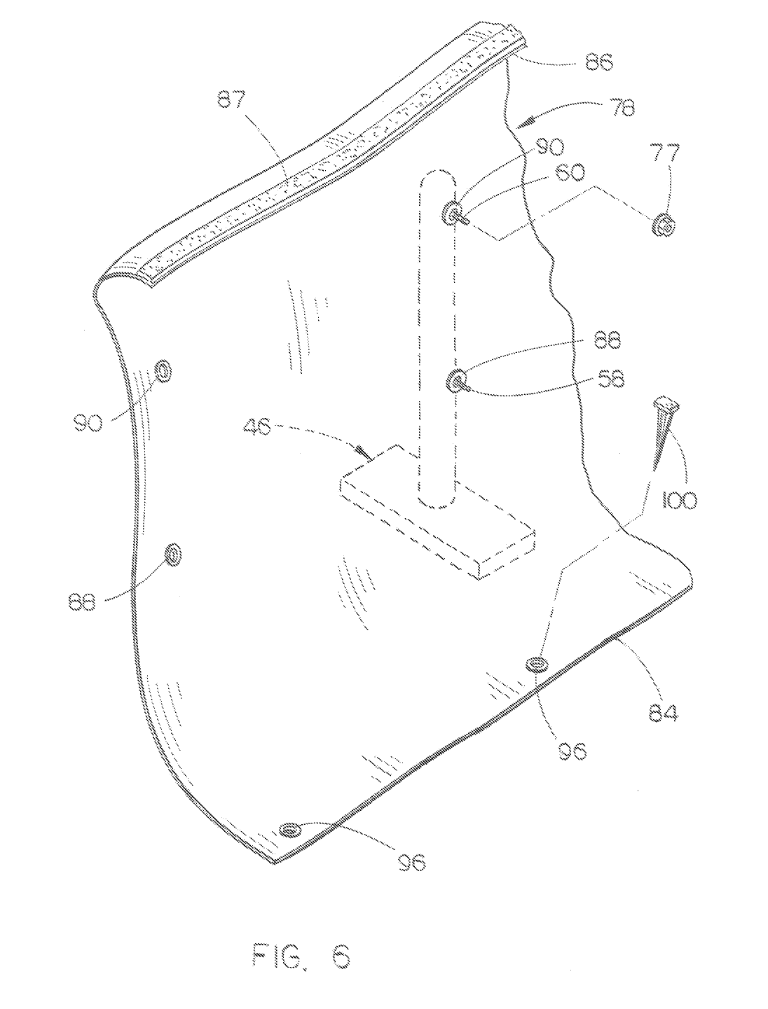

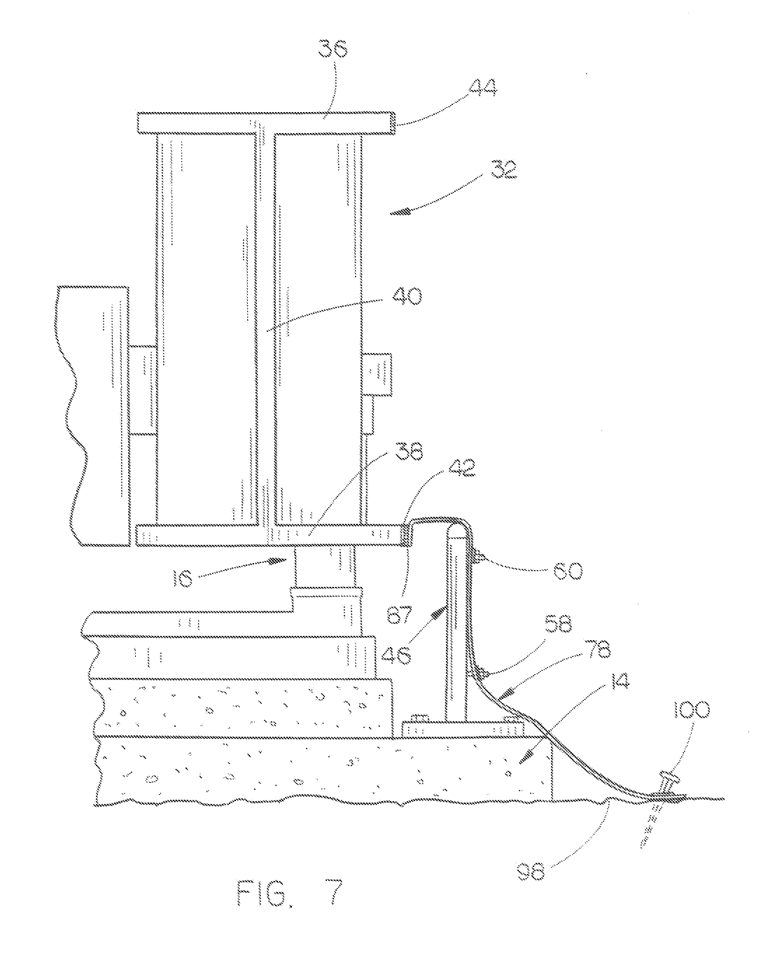

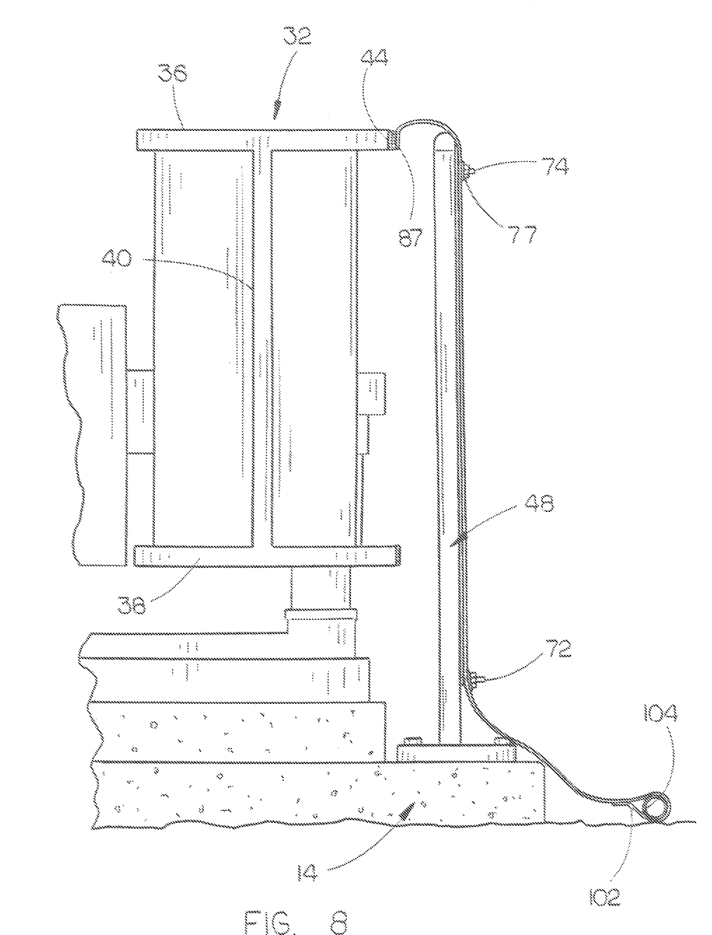

The numeral 46 refers to a “short” support post while the numeral 48 refers to a “long” support post. The support post 46 will be utilized when the VELCRO® strip 42 is secured to the outer end of the lower flange 38 while the support post 48 will be utilized when the VELCRO® strip 44 is secured to the outer end of upper flange 36. The only difference between the support post 46 and the support post 48 is the length thereof. In some cases, when the frame siderail of the truck scale 10 has a height of 12 inches, the short support post 46 will be utilized in conjunction with a VELCRO® strip secured to the outer end of the lower flange of the frame siderail, as seen in FIGS. 1 and 7. When the frame siderail has a height of 24 inches, the long support posts 48 will normally be utilized in conjunction with a VELCRO® strip being secured to the outer end of the upper flange of the frame siderail.

Support post 46 includes a base 50 having openings 52 and 54 formed therein. Post portion 56 extends upwardly from base 50 and has a pair of vertically spaced-apart threaded studs 58 and 60 therefrom. Preferably, the upper end of the post portion 62 is rounded.

Support post 48, which will be utilized with the instant invention, includes a base 64 having openings 66 and 68 formed therein. Post portion 70 extends upwardly from base 64 and has a pair of vertically spaced-apart threaded studs 72 and 74 extending therefrom. Preferably, the upper end 76 of the post portion 70 is rounded. The studs 58, 60, 72 and 74 are adapted to threadably receive nuts 77 thereon.

The numeral 78 refers to a generally rectangular, flexible sheet member or seal having ends 80 and 82, a lower edge 84 and an upper edge 86. A VELCRO® strip 87 is provided on the upper end of sheet member 78 for attachment to the strips 44. A plurality of pairs of grommets 88 and 90 are provided in sheet member 78 between the ends thereof which are adapted to receive the threaded studs 72 and 74 of the support posts 48. Sheet member 78 is positioned at side 24 of the truck scale 10 and an identical sheet member will be located at the second side 26 of the truck scale. Sheet member 78 includes end flaps 92 and 94 at the ends 80 and 82 thereof respectively which are secured to the ends of the associated frame siderail to close the ends of the gap as seen in FIG. 9. The lower end of the sheet member may have a plurality of spaced-apart grommets 96 provided therein to enable the lower end of sheet member 78 to be secured to the ground 98 adjacent the scale or supporting foundation 14 by stakes 100 as seen in FIG. 9. The lower end of sheet member 78 may also have a loop 102 formed therein which receives an elongated weighted rod 104 to hold the lower end of sheet member 78 in place.

The bases of posts 48 are bolted to the foundation 14 as seen in FIGS. 7 and 8. The posts 48 support the sheet member 78 in place as seen in the drawings. The upper areas of the sheet member provide some “play” therein to enable the scale deck 12 to move somewhat in a weighing operation without impeding the accuracy of the scale. The sheet member at each side of the truck scale (FIG. 8) prevents wind from impinging upon the truck scale so that the wind will not affect the accuracy of the scale.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination:
a substantially horizontally disposed supporting surface, having an entry end, an exit end, a first side and a second side;
a substantially horizontally disposed scale deck positioned above said supporting surface having an entry end, an exit end, a first side, a second side, an upper end and a lower end;
a plurality of spaced-apart load cells positioned between said scale deck and said supporting surface;
said lower end of said scale deck being positioned above said supporting surface to create a gap therebetween at each of said first and second sides thereof;
said scale deck having first and second longitudinally extending frame siderails at said first and second sides thereof;
each of said first and second frame siderails having a first end, a second end, inner and outer sides and upper and lower ends;
a first elongated flexible sheet member having an upper end, a lower end, a first end, a second end, an inner side and an outer side;
said upper end of said first sheet member being secured to said first frame siderail, at said upper end thereof, so that said first end thereof is positioned adjacent said first end of said first frame siderail and so that said second end thereof is positioned adjacent said second end of said first frame siderail;
said first sheet member extending downwardly from its said upper end to shield said first side of said scale deck;
said lower end of said first sheet member being operatively secured in place to prevent wind from engaging said first side of said scale deck;
a second elongated flexible sheet member having an upper end, a lower end, a first end, a second end, an inner side and an outer side;
said upper end of said second sheet member being secured to said second frame siderail, at said upper end thereof, so that said first end thereof is positioned adjacent said first end of said second frame siderail and so that said second end thereof is positioned adjacent said second end of said second frame siderail;
said second sheet member extending downwardly from its said upper end to shield said second side of said scale deck;
said lower end of said second sheet member being operatively secured in place to prevent wind from engaging said second side of said scale deck.

2. The combination of claim 1 wherein a plurality of horizontally spaced-apart and vertically extending support posts having upper and lower ends, are positioned outwardly of said first and second sides of said first and second frame siderails respectively and wherein said first and second sheet members are selectively removably secured to said support posts.

3. The combination of claim 1 wherein said lower ends of said first and second sheet members are selectively removably secured to the ground adjacent said supporting surface.

4. The combination of claim 1 wherein said upper ends of said first and second sheet members are selectively removably secured to said first and second frame siderails respectively.

5. The combination of claim 2 wherein each of said first and second frame siderails have an upper flange with inner and outer ends, a lower flange with inner and outer ends, and a web extending therebetween and wherein said upper end of said first sheet member is secured to said outer end of said upper flange of said first frame siderail and wherein said upper end of said second sheet member is secured to said outer end of said upper flange of said second frame siderail.
